(19) United States
(12) Patent Application Publication
(10) Pub. No.: US 2012/0170271 A1
(43) Pub. Date: Jul. 5, 2012

(54) LED SCREEN, PARTICULARLY FOR OUTDOOR ENVIRONMENTS

(76) Inventor: Marco Bertelé, Lurago d'Erba (IT)

(21) Appl. No.: 13/395,074

(22) PCT Filed: Aug. 5, 2010
(86) PCT No.: PCT/EP2010/061448

§ 371 Date: Mar. 8, 2012

(30) Foreign Application Priority Data
Sep. 11, 2009 (IT) MI2009A001562

(51) Int. Cl. F21V 21/00

(52) U.S. Cl. 362/249.02

(57) ABSTRACT

An LED screen, particularly for outdoor environments, comprising a main structure containing a printed circuit which defines a plurality of LEDs that protrude from a front opening defined by the main structure, the LED screen comprising an element for the outer covering of the printed circuit which defines a plurality of holes for the insertion of the LEDs and which can be fixed, by way of fixing means, to a perforated plate that can be fixed to the main structure at the lower base of the LEDs.

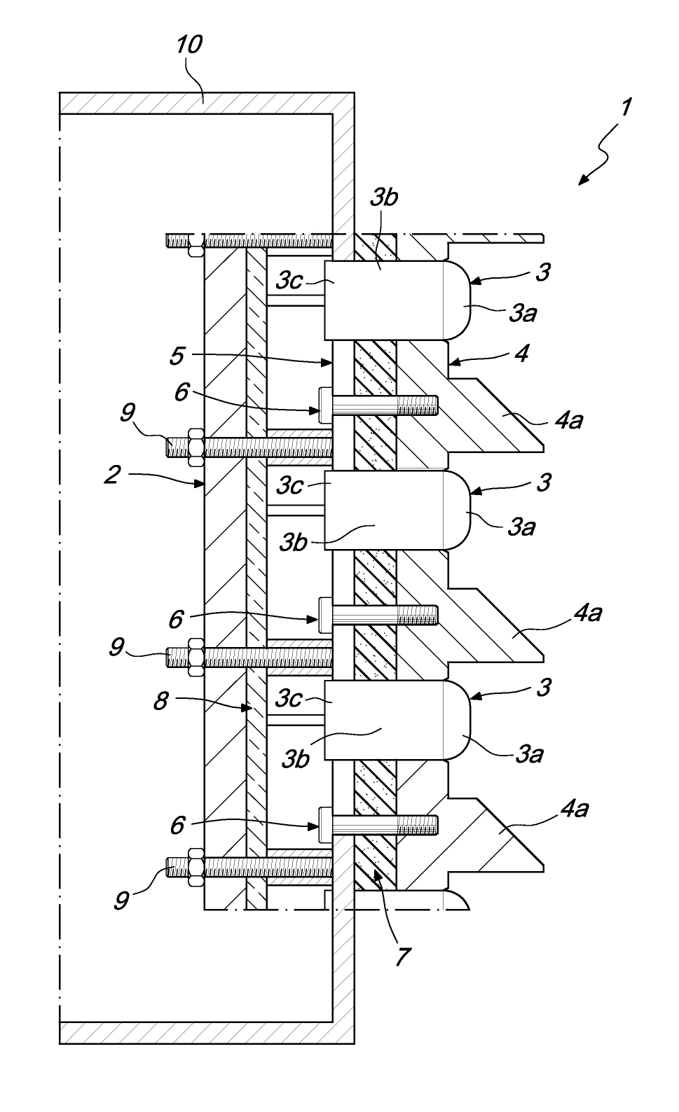

### TECHNICAL FIELD

The present invention relates to an LED screen, particularly for outdoor environments.

### BACKGROUND ART

Nowadays, LED screens are widespread, especially in locations where it is necessary to have a visual communication device with high contrast and at low cost.

When the LED screen is used outdoors, it becomes necessary to shelter it from atmospheric agents or, more specifically, to shelter the printed circuit that contains the LEDs.

To overcome this problem, a first generation of LED screens has a transparent membrane that externally covers the screen, thereby protecting the printed circuit.

Such membrane, although having a low cost and ensuring easy maintenance of the screen, alters the optical features of the LEDs by causing undesired reflections on its surface such as, for example, the reflection of the ambient light.

For preventing the formation of such reflections, a plurality of light hoods can be provided on the transparent membrane; despite the presence of such light hoods, LED screens of this first generation suffer the drawback of having a low level of visual contrast.

In a second generation of LED screens of known type, a layer of isolating material such as, for example, black silicone resin is deposited on the side of the printed circuit that faces outwards.

Such layer is deposited on the printed circuit, embedding the lower portion of the LEDs in the resin in such a way as to prevent water or foreign substances from reaching the printed circuit.

This solution, which has the advantages of leaving the optical features of the LEDs unaltered, giving the system an excellent level of visual contrast that is free from reflections, suffers the drawback that it does not make the printed circuit on the LED side accessible to the operator, in order to repair and replace the electronic components. In the majority of cases, in the event of breakdown, this leads to the replacement of the entire electronic card.

### DISCLOSURE OF THE INVENTION

The aim of the present invention is to eliminate the aforementioned drawbacks, by providing an LED screen, particularly for outdoor environments, which provides a system for protecting the printed circuit from atmospheric agents and/or the like.

Within this aim, an object of the present invention is to provide an LED screen that has a printed circuit with the electronic components soldered onto it that are free from silicone or resin encapsulation, in such a way as to allow the operator to carry out, for example, maintenance operations.

Another object of the present invention is to provide an LED screen that has an inner circulation of air that can cool the LEDs. The distinctive characteristic of the invention is the creation of a space between the printed circuit and the rigid plate. This allows a natural (or forced) circulation of air, which, since it is heated by the LEDs and by solar radiation, can flow, allowing the LEDs to not overheat.

Another object of the present invention is to provide an LED screen with an excellent level of contrast that is free from reflections owing to ambient light, in such a way as to leave the optical features of the LEDs unaltered.

This aim, as well as these and other objects which will become better apparent hereinafter, are achieved by an LED screen, particularly for outdoor environments, comprising a main structure containing a printed circuit which defines a plurality of LEDs that protrude from a front opening defined by said main structure, characterized in that it comprises an element for the outer covering of said printed circuit which defines a plurality of holes for the insertion of said LEDs and can be fixed, by way of fixing means, to a perforated plate that can be fixed to said main structure at the lower base of said LEDs, at least one gasket element being removably interposed between said covering element and said perforated plate and surrounding hermetically the central body of each one of said LEDs.

### BRIEF DESCRIPTION OF THE DRAWINGS

Further characteristics and advantages of the present invention will become better apparent from the description of a preferred, but not exclusive, embodiment of an LED screen, particularly for outdoor environments, according to the invention, illustrated by way of a non-limiting example in the accompanying drawing wherein the sole FIGURE is a cross-sectional view of an embodiment of an LED screen according to the present invention.

### WAYS OF CARRYING OUT THE INVENTION

With reference to the FIGURE, the LED screen, particularly for outdoor environments, indicated generally with the reference numeral 1, comprises a main structure 10, which can consist of a frame containing a printed circuit 2 which defines a plurality of LEDs 3 that are oriented substantially parallel to each other and arranged in rows that are parallel to each other, protruding from a front opening defined by the main structure.

According to the invention, the screen 1 comprises an element 4 for the outer covering of the printed circuit, defined by a faceplate made of plastics such as, for example, polycarbonate and defining a plurality of holes for the insertion of LEDs 3 in such a way as to make the luminous parte 3a of the LEDs 3 protrude.

More precisely, the covering element 4 is such as to make the luminous part 3a of the LEDs 3 protrude by about 3 mm externally.

The covering element 4 can be fixed parallel to a perforated plate 5 which is defined by a metal sheet such as, for example, stainless steel.

Advantageously, the covering element 4 comprises a plurality of crests 4a, with a suitable asymmetric wedge shape, which act as light hood elements, aligned with each other so as to pass between the rows of LEDs 3.

More specifically, when seen in cross-section, the crests 4a have an asymmetric wedge-like profile in order to define an upper angle of incidence, the angle of incidence of the sun rays, that is much smaller than the lower angle of incidence, the angle of incidence of the vision of the screen 1 by people who are almost underneath it.

The plate 5 can be fixed, in turn, to the main structure so as to be parallel to the printed circuit.

The fixing of the plate 5, which is located at the lower base 3c of the LEDs 3, to the covering element 4, is achieved by fixing means 6 which can, for example, be constituted by a plurality of screws inserted in abutment into through holes defined in the perforated plate 5 from the side facing the printed circuit 2, so as to then be screwed into threaded holes defined in the covering element 4 at the crests 4a.

Advantageously, the use of removable fixing means 6 makes it possible to remove the covering element 4.

The printed circuit 2 is fixed to the plate 5 by means of threaded supports 9.

Advantageously the printed circuit 2 can be easily removed from the plate 5 and, since its surface is free from silicone resins or the like, it can be easily repaired.

In order to ensure a correct isolation of the printed circuit 2 from the outside environment, between the covering element 4 and the perforated plate 5 at least one gasket element 7, constituted by a membrane made of a rubberlike material such as, for example, neoprene, is removably interposed.

The gasket element 7 comprises a first plurality of through holes for the passage of the screws of the fixing means 6 and a second plurality of holes in order to hermetically surround the central body 3b of each of the LEDs 3.

A further protective element of the printed circuit 2 can be constituted by a transparent film 8 which is made, for example, from water-repellent transparent resin that is applied to the printed circuit 2 by means of immersion of the side that define said LEDs.

In practice it has been found that the LED screen, particularly for outdoor environments, according to the present invention fully achieves the intended aim and objects, insofar as it protects the printed circuit from atmospheric agents while at the same time allowing its easy removal by decoupling it from the threaded supports fixed to the plate 5.

Another advantage of the LED screen according to the present invention consists in that the optical features of the LEDs are unaltered, since the luminous portion of the LEDs are not covered in any way.

A further advantage of the LED screen according to the present invention consists in that it has an excellent level of visual contrast that is free from reflections, owing to the special profile of the covering element 4a.

Another advantage of the LED screen according to the present invention consists in that it is clearly visible even by people who are almost directly underneath the screen proper.

Moreover, the plate 5, the gasket element 7 and the outer covering element 4 and 4a make it possible to create a space between the printed circuit and the front surface of the containment box, such space allowing the formation of a flow of cooling air.

The LED screen, particularly for outdoor environments, thus conceived, is susceptible of numerous modifications and variations, all of which are within the scope of the appended claims.

Moreover, all the details may be substituted by other, technically equivalent elements.

In practice the materials employed, provided they are compatible with the specific use, and the dimensions and the contingent shapes, may be any according to requirements and to the state of the art.

The disclosures in Italian Patent Application No. MI2009A001562from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-9. (canceled)

10. An LED screen, particularly for outdoor environments, comprising a main structure containing a printed circuit which defines a plurality of LEDs that protrude from a front opening defined by said main structure, further comprising an element for the outer covering of said printed circuit which defines a plurality of holes for the insertion of said LEDs and can be fixed, by way of fixing means, to a perforated plate that can be fixed to said main structure at the lower base of said LEDs, at least one gasket element being removably interposed between said covering element and said perforated plate and surrounding hermetically the central body of each one of said LEDs.

11. The screen according to claim 10, further comprising a transparent film that is applied to said printed circuit on the side that defines said LEDs.

12. The screen according to claim 10, wherein said fixing means comprise a plurality of screws, which are inserted in through holes defined in said perforated plate and in said gasket element and can be screwed into threaded holes defined in said covering element, said screws abutting against said perforated plate on the side that faces said printed circuit.

13. The screen according to claim 10, wherein said covering element comprises a plurality of crests which are mutually aligned at said threaded holes and pass between said rows of said LEDs.

14. The screen according to claim 13, wherein said crests have, in a transverse cross-section, an asymmetric wedge-like profile.

15. The screen according to claim 14, wherein said asymmetric wedge defines an upper angle of incidence that is smaller than the lower angle of incidence.

16. The screen according to claim 10, wherein said covering element is a faceplate made of plastics.

17. The screen according to claim 10, wherein said gasket element is a membrane made of rubberlike material.

18. The screen according to claim 17, wherein said rubberlike material of said membrane is neoprene.
